(19) United States
(12) Patent Application Publication
(10) Pub. No.: US 2025/0251023 A1
(43) Pub. Date: Aug. 7, 2025

(54) OVERLOAD PROTECTION DEVICE

(71) Applicant: TSUBAKIMOTO CHAIN CO., Osaka (JP)

(72) Inventors: Hiroyuki KAMIHIGASHI, Osaka (JP); Akihiro FUKUDA, Osaka (JP); Minoru KOMADA, Osaka (JP)

(73) Assignee: TSUBAKIMOTO CHAIN CO., Osaka (JP)

(21) Appl. No.: 19/017,951

(22) Filed: Jan. 13, 2025

(30) Foreign Application Priority Data
Feb. 1, 2024 (JP) 2024-014012

(51) Int. Cl. F16D 7/02

(52) U.S. Cl. CPC F16D 7/028

(57) ABSTRACT

To provide a simple-structured overload protection device. The overload protection device allows torque transmission between an inner rotating member and an outer rotating member that are coaxial and rotatable relative to each other, and is able to interrupt the transmission of torque exceeding a permissible level. The overload protection device includes an inner ring having an inner transmission surface in contact with an outer circumferential surface of the inner rotating member, and a first taper surface, and an outer ring having an outer transmission surface in contact with an inner circumferential surface of the outer rotating member, and a second taper surface that makes contact with the first taper surface of the inner ring. The overload protection device is configured to be able to press the inner ring and the outer ring to come closer to each other in an axial direction.

### BACKGROUND OF THE INVENTION

### 1. Field of the Invention

The present invention relates to an inner rotating member and an outer rotating member coaxial and rotatable relative to each other, and an overload protection device that allows torque transmission between the inner and outer rotating members and is able to interrupt the transmission of torque exceeding a permissible level.

### 2. Description of the Related Art

In transmitting torque between two axes, it is known to use an overload protection device that is able to interrupt the transmission of torque exceeding a permissible level.

Configurations that transmit torque using static friction obtained by applying pressure, similar to friction-type clutch discs, are known. The pressure to be applied is set suitably so that the clutch slips when overloaded.

Also known is an overload protection device, as described in Japanese Patent No. 7006664, which transmits torque between an inner rotating member and an outer rotating member that are coaxial and rotatable relative to each other, and is able to interrupt the transmission of torque exceeding a permissible level.

The overload protection device described in Japanese Patent No. 7006664 includes an outer rotating member (second main body 20) with a plurality of concave and arcuate engaging portions (221) on the inner circumferential surface. A drive member (30) is biased radially outward from an inner rotating member (first main body 10) and pressed against one of the engaging portions (221), which enables a torque to be transmitted. A torque exceeding a permissible level pushes the drive member (30) back against the biasing force toward the inner rotating member to interrupt the torque transmission.

### SUMMARY OF THE INVENTION

The configuration that uses friction similarly to known clutch discs requires a large pressing force relative to a torque to be transmitted. One problem with this type of clutch is that it is hard to accurately set the torque at which the transmission should be interrupted, because the torque at which slipping occurs can change largely depending on an even slight difference in the tightening force applied when bolts or the like are fastened.

The overload protection device described in Japanese Patent No. 7006664 is configured by the torque transmission mechanism between the inner rotating member and the outer rotating member. While the device can be designed smaller, the complex shape of both the inner rotating member and the outer rotating member will pose the problem of high machining costs.

Moreover, torque is transmitted at one point on the circumference, and the number of torque transmitting points cannot be more than the number of the engaging portions (221). Therefore, the transmitted torque could be increased only to a limited extent.

The pressing force, which is applied by a resilient member, to bias the drive member (30), is limited. This is another reason why the transmitted torque cannot readily be increased. The resilient member is set in a small space and required to impart a large pressing force with a short stroke. This makes it challenging to increase the setting accuracy of a permissible torque.

For transmitting a large torque, it is conceivable to use a common one-way cam clutch as an overload protection device to limit the torque to a permissible level.

However, once the torque applied to the cam clutch exceeds the permissible level and the torque transmission is interrupted, the cam clutch remains in that state and does not revert to the torque-transmissible state. Therefore, while a cam clutch can be used as an emergency overload protection device, it is not suitable for applications where it is required to be usable continuously even after a torque overload, when the torque returns to a normal level.

The present invention solves these problems and aims to provide a simple-structured overload protection device that enables a reduction in machining costs, an increase in transmitted torque, an improvement in the setting accuracy of a permissible torque, and continuous use even after a torque overload when the torque returns to a normal level.

The present invention achieves the above object by providing an overload protection device that allows torque transmission between an inner rotating member and an outer rotating member that are coaxial and rotatable relative to each other, and is able to interrupt the transmission of torque exceeding a permissible level, the device including: an inner ring; an outer ring; and a torque adjustment mechanism. The inner ring includes an inner transmission surface in contact with an outer circumferential surface of the inner rotating member, and a first taper surface on a radially outer side, and the outer ring includes an outer transmission surface in contact with an inner circumferential surface of the outer rotating member, and a second taper surface that makes contact with the first taper surface of the inner ring. The inner ring and the outer ring are configured to be inserted between the inner rotating member and the outer rotating member, with the first taper surface and the second taper surface contacting each other. The torque adjustment mechanism is configured to press the inner ring and the outer ring to come closer to each other in an axial direction.

According to the invention set forth in aspect 1, the inner ring and the outer ring are configured to be inserted between the inner rotating member and the outer rotating member, with the first taper surface and the second taper surface contacting each other, and to be pressed together to come closer to each other in an axial direction, so that the wedge effect allows a large torque to be transmitted.

The structure is simple so that the machining cost is low. The device can be used continuously even after a torque overload, when the torque returns to a normal level. A certain level of torque can be transmitted even during the application of an overload.

A large axial stroke available for the pressing can increase the setting accuracy of a permissible torque.

According to the configuration set forth in aspect 2, the torque adjustment mechanism includes an internally threaded hole formed in the outer ring such as to extend in an axial direction, a screw hole formed in the inner ring, and a screw member that passes through the screw hole and engages with the internally threaded hole. The mechanism uses only a small number of components, which further simplifies the device structure.

According to the configuration set forth in aspect 3, the device further includes a pressing member that presses one or both of the inner ring and the outer ring toward a restricting portion. This configuration enables a size reduction of the gap between the inner rotating member and the outer rotating member, as well as a size reduction of the inner ring and outer ring, which enables a radial size reduction of the device.

According to the configuration set forth in aspect 4, the static friction between the inner transmission surface of the inner ring and the outer circumferential surface of the inner rotating member is set to be smaller than the static friction between the outer transmission surface of the outer ring and the inner circumferential surface of the outer rotating member. In this way, specific surfaces are caused to slip when the torque exceeds a permissible level, which enables more accurate setting of a permissible torque.

According to the configurations set forth in aspects 5 to 7, possible damage to various surfaces when they slip upon application of a torque exceeding the permissible level can be minimized, which enables continuous use after the torque has returned to the normal level.

The configurations also minimize adhesion that occurs with prolonged tight contact (change in permissible torque over time) and reduce noise when slipping occurs.

### BRIEF DESCRIPTION OF THE DRAWINGS

FIG. 1 is a partially cross-sectional side view of an overload protection device according to a first embodiment of the present invention;

FIG. 2 is a perspective view of an inner ring and an outer ring of FIG. 1;

FIG. 3 is an exploded perspective view of the inner ring and outer ring of FIG. 1;

FIG. 4 is a partially cross-sectional side view of an overload protection device according to a second embodiment of the present invention;

FIG. 5 is an exploded perspective view of the inner ring and outer ring of FIG. 4 (and FIG. 6); and

FIG. 6 is a partially cross-sectional side view of an overload protection device according to a third embodiment of the present invention.

### DESCRIPTION OF THE PREFERRED EMBODIMENTS

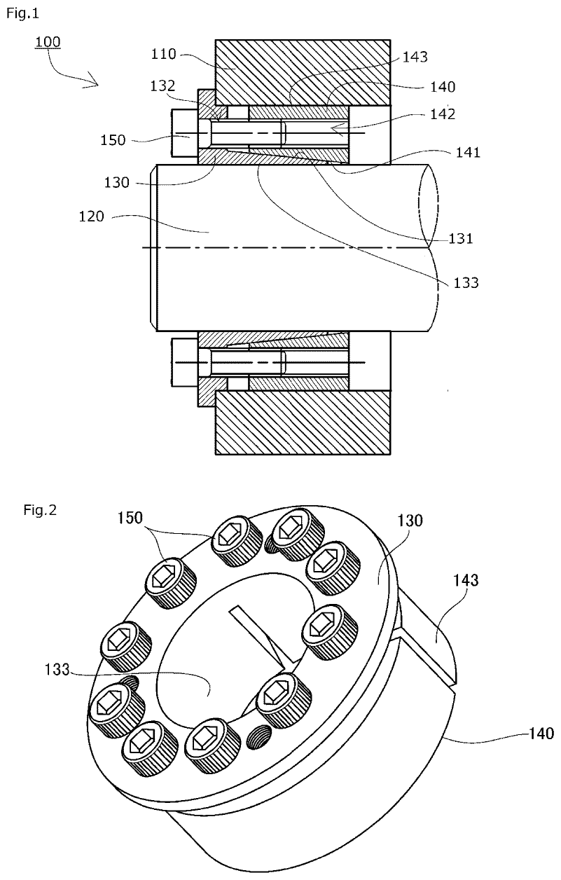

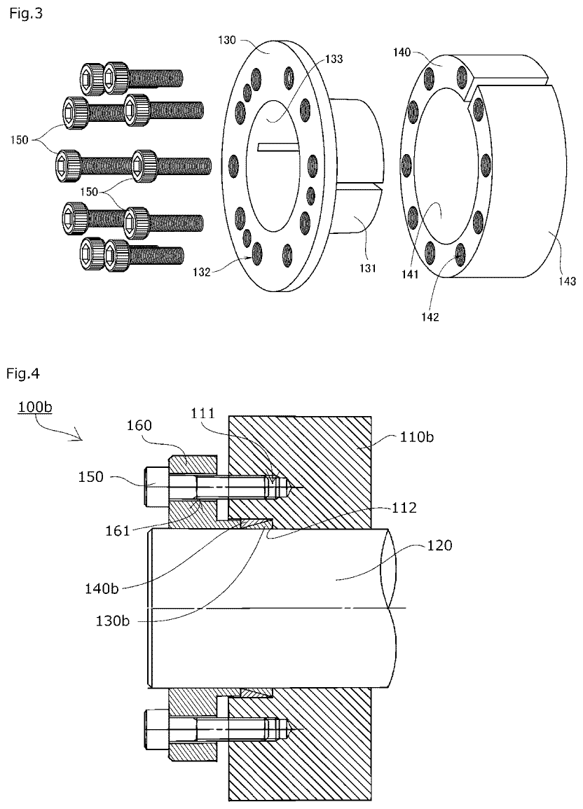

Examples of the present invention are described with reference to FIG. 1 to FIG. 6. Note, however, the present invention is not limited to these embodiments.

### Examples

The overload protection device 100 according to the first embodiment of the present invention includes: an inner rotating member 120 and an outer rotating member 110 that are coaxial and rotatable relative to each other; and an inner ring 130 and an outer ring 140 that transmit torque between the inner rotating member 120 and the outer rotating member 110, as shown in FIG. 1 to FIG. 3.

The inner rotating member 120 has a cylindrical outer circumferential surface, and the outer rotating member 110 has a cylindrical inner circumferential surface. Likewise, the inner ring 130 has a cylindrical inner circumferential surface, and the outer ring 140 has a cylindrical outer circumferential surface.

The inner ring 130 includes an inner transmission surface 133 in contact with the outer circumferential surface of the inner rotating member 120, and a first taper surface 131 on the radially outer side.

The outer ring 140 includes an outer transmission surface 143 in contact with the inner circumferential surface of the outer rotating member 110, and a second taper surface 141 that makes contact with the first taper surface 131 of the inner ring 130.

The inner ring 130 and outer ring 140 are configured to be inserted between the inner rotating member 120 and the outer rotating member 110, with their first taper surface 131 and second taper surface 141 contacting each other.

The outer ring 140 is provided with internally threaded holes 142 extending in the axial direction, and the inner ring 130 is provided with screw holes 132. Screw members 150 are passed through the screw holes 132, and engaged with and tightened into the internally threaded holes 142, to press the inner ring 130 and outer ring 140 closer together in the axial direction. The first taper surface 131 and second taper surface 141 exert a force that acts to push apart the outer circumferential surface of the inner rotating member 120 and the inner circumferential surface of the outer rotating member 110. This causes static friction between the inner transmission surface 133 and the outer circumferential surface of the inner rotating member 120, and between the outer transmission surface 143 and the inner circumferential surface of the outer rotating member 110, allowing a torque to be transmitted.

In this embodiment, when the screw members 150 are fastened, the static friction between the inner transmission surface 133 and the outer circumferential surface of the inner rotating member 120 is smaller than the static friction between the outer transmission surface 143 of the outer ring 140 and the inner circumferential surface of the outer rotating member 110.

In this embodiment, the inner transmission surface 133 of the inner ring 130 is coated with a high-hardness material such as VC, CrN, and DLC so that it has excellent wear resistance and durability. Moreover, the hard and smooth surface has a consistent friction coefficient.

The wear-resistant, durable inner transmission surface 133 of the inner ring 130 is always able to reliably slip to interrupt the transmission of rotation when a torque exceeding a permissible level is applied, and to maintain the torque stably within a permissible range even after a large number of operations.

The surface coating also helps stabilize the relationship between the tightening amount of the screw members 150 and the permissible torque (static friction between the inner transmission surface 133 and the outer circumferential surface of the inner rotating member 120), which allows accurate setting of a permissible torque.

The surface hardness should preferably be HV1500 or more.

The overload protection device 100b according to the second embodiment of the present invention includes: an inner rotating member 120 and an outer rotating member 110b that are coaxial and rotatable relative to each other; an inner ring 130b and an outer ring 140b that transmit torque between the inner rotating member 120 and the outer rotating member 110b; and a pressing member 160 that presses the outer ring 140b in an axial direction, as shown in FIG. 4 and FIG. 5.

The inner rotating member 120 has a cylindrical outer circumferential surface, and the outer rotating member 110b has a cylindrical inner circumferential surface. Likewise, the inner ring 130b has a cylindrical inner circumferential surface, and the outer ring 140b has a cylindrical outer circumferential surface.

A restricting portion 112 that restricts axial movement of the inner ring 130b is provided on the inner circumference of the outer rotating member 110b.

The inner ring 130b includes an inner transmission surface 133 in contact with the outer circumferential surface of the inner rotating member 120, and a first taper surface 131 on the radially outer side.

The outer ring 140b includes an outer transmission surface 143 in contact with the inner circumferential surface of the outer rotating member 110b, and a second taper surface 141 that makes contact with the first taper surface 131 of the inner ring 130b.

The inner ring 130b and outer ring 140b are configured to be inserted between the inner rotating member 120 and the outer rotating member 110b, with their first taper surface 131 and second taper surface 141 contacting each other.

The pressing member 160 is provided with screw holes 161, and configured to lightly engage with the inner rotating member 120 such as to be able to axially press the outer ring 140b that is inserted between the inner rotating member 120 and the outer rotating member 110b.

The outer rotating member 110b is provided with internally threaded holes 111 that extend in the axial direction. Screw members 150 are passed through the screw holes 161 of the pressing member 160, and engaged with and tightened into the internally threaded holes 111, so that the pressing member 160 and the restricting portion 112 of the outer rotating member 110b press the inner ring 130b and outer ring 140b closer together in the axial direction. The first taper surface 131 and second taper surface 141 exert a force that acts to push apart the outer circumferential surface of the inner rotating member 120 and the inner circumferential surface of the outer rotating member 110. This causes static friction between the inner transmission surface 133 and the outer circumferential surface of the inner rotating member 120, between the first taper surface 131 and the second taper surface 141, and between the outer transmission surface 143 and the inner circumferential surface of the outer rotating member 110b, allowing a torque to be transmitted.

In this embodiment, when the screw members 150 are fastened, the static friction between the inner transmission surface 133 and the outer circumferential surface of the inner rotating member 120 is smaller than the static friction between the outer transmission surface 143 of the outer ring 140b and the inner circumferential surface of the outer rotating member 110b and the static friction between the first taper surface 131 and the second taper surface 141.

In this embodiment, too, the inner transmission surface 133 of the inner ring 130b is coated with a high-hardness material such as VC, CrN, and DLC so that it has excellent wear resistance and durability. Moreover, the hard and smooth surface has a consistent friction coefficient.

The wear-resistant, durable inner transmission surface 133 of the inner ring 130b is always able to reliably slip to interrupt the transmission of rotation when a torque exceeding a permissible level is applied, and to maintain the torque stably within a permissible range even after a large number of operations.

The surface coating also helps stabilize the relationship between the tightening amount of the screw members 150 and the permissible torque (static friction between the inner transmission surface 133 and the outer circumferential surface of the inner rotating member 120), which allows accurate setting of a permissible torque.

The inner ring 130b and outer ring 140b in this embodiment can be made thin and are not provided with a slit for allowing deformation. Alternatively, both rings may be provided with a slit at one point on their circumference similarly to the inner ring 130 and outer ring 140 of the first embodiment.

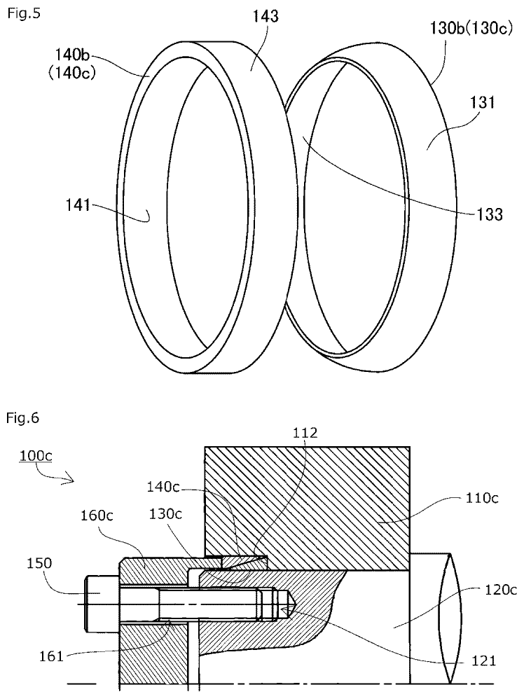

The overload protection device 100c according to the third embodiment of the present invention includes: an inner rotating member 120c and an outer rotating member 110c that are coaxial and rotatable relative to each other; an inner ring 130c and an outer ring 140c that transmit torque between the inner rotating member 120c and the outer rotating member 110c; and a pressing member 160c that presses the outer ring 140c in an axial direction, as shown in FIG. 5 and FIG. 6.

The inner rotating member 120c has a cylindrical outer circumferential surface, and the outer rotating member 110c has a cylindrical inner circumferential surface. Likewise, the inner ring 130c has a cylindrical inner circumferential surface, and the outer ring 140c has a cylindrical outer circumferential surface.

A restricting portion 112 that restricts axial movement of the outer ring 140c is provided on the inner circumference of the outer rotating member 110c. The outer rotating member 110c is restricted from moving relative to the inner rotating member 120c in the direction in which the pressing member 160c is pressed, as will be described later.

The inner ring 130c includes an inner transmission surface 133 in contact with the outer circumferential surface of the inner rotating member 120c, and a first taper surface 131 on the radially outer side.

The outer ring 140c includes an outer transmission surface 143 in contact with the inner circumferential surface of the outer rotating member 110c, and a second taper surface 141 that makes contact with the first taper surface 131 of the inner ring 130c.

The inner ring 130c and outer ring 140c are configured to be inserted between the inner rotating member 120c and the outer rotating member 110c, with their first taper surface 131 and second taper surface 141 contacting each other.

The pressing member 160c is provided with screw holes 161, and configured to lightly engage with the inner rotating member 120c such as to be able to axially press the outer ring 140c that is inserted between the inner rotating member 120c and the outer rotating member 110c.

The inner rotating member 120c is provided with internally threaded holes 121 that extend in the axial direction. Screw members 150 are passed through the screw holes 161 of the pressing member 160c, and engaged with and tightened into the internally threaded holes 121. This presses the inner ring 130c and outer ring 140c closer together in the axial direction, between the pressing member 160c and the restricting portion 112 of the outer rotating member 110c, which is restricted from moving relative to the inner rotating member 120c in the direction in which the pressing member 160c is pressed. The first taper surface 131 and second taper surface 141 exert a force that acts to push apart the outer circumferential surface of the inner rotating member 120c and the inner circumferential surface of the outer rotating member 110c. This causes static friction between the inner transmission surface 133 and the outer circumferential surface of the inner rotating member 120c, between the first taper surface 131 and the second taper surface 141, and between the outer transmission surface 143 and the inner circumferential surface of the outer rotating member 110c, allowing torque to be transmitted.

In this embodiment, similarly to the second embodiment, when the screw members 150 are fastened, the static friction between the inner transmission surface 133 and the outer circumferential surface of the inner rotating member 120c is smaller than the static friction between the outer transmission surface 143 of the outer ring 140c and the inner circumferential surface of the outer rotating member 110c, and the static friction between the first taper surface 131 and the second taper surface 141.

In this embodiment, too, the inner transmission surface 133 of the inner ring 130c is coated with a high-hardness material such as VC, CrN, and DLC so that it has excellent wear resistance and durability. Moreover, the hard and smooth surface has a consistent friction coefficient.

The wear-resistant, durable inner transmission surface 133 of the inner ring 130c is always able to reliably slip to interrupt the transmission of rotation when a torque exceeding a permissible level is applied, and to maintain the torque stably within a permissible range even after a large number of operations.

The surface coating also helps stabilize the relationship between the tightening amount of the screw members 150 and the permissible torque (static friction between the inner transmission surface 133 and the outer circumferential surface of the inner rotating member 120c), which allows accurate setting of a permissible torque.

In this embodiment, when the torque exceeds the permissible level, the outer ring 140c and the pressing member 160c also slip in their contacting parts. The axial pressing force in these contacting parts is smaller than the radial pressing force of other surfaces, and the static friction is small, so the static friction is negligible in the setting of the permissible torque.

In each of the embodiments described above, the permissible torque in actual use may be set on the basis of a tightening torque applied using a torque wrench or the like.

The permissible torque in actual use may also be controlled on the basis of a rotation angle of the screw members 150. When there is a gap between the pressing member 160 and the outer rotating member 110b, or between the pressing member 160c and the inner rotating member 120c as in the second and third embodiments, the permissible torque may be controlled on the basis of the size of this gap. A preset permissible torque can be set by tightening the screw members until there is no gap.

While embodiments of the present invention have been described in detail, the present invention is not limited to the above-described embodiments and may be carried out with various design changes without departing from the scope of the present invention set forth in the aspects.

For example, the screw holes in each embodiment may be replaced with screw shafts, for nut members to engage therewith.

A mechanism for moving the pressing member in the pressing direction may be configured to directly connect the pressing member itself in screw engagement with the inner rotating member or the outer rotating member for the movement in the axial direction.

What is claimed is:

1. An overload protection device that allows torque transmission between an inner rotating member and an outer rotating member that are coaxial and rotatable relative to each other, and is able to interrupt the transmission of torque exceeding a permissible level, the device comprising:
an inner ring;
an outer ring; and
a torque adjustment mechanism,
the inner ring having an inner transmission surface in contact with an outer circumferential surface of the inner rotating member, and a first taper surface on a radially outer side,
the outer ring having an outer transmission surface in contact with an inner circumferential surface of the outer rotating member, and a second taper surface that makes contact with the first taper surface of the inner ring,
the inner ring and the outer ring being configured to be inserted between the inner rotating member and the outer rotating member, with the first taper surface and the second taper surface contacting each other,
the torque adjustment mechanism being configured to press the inner ring and the outer ring to come closer to each other in an axial direction.

2. The overload protection device according to claim 1, wherein the torque adjustment mechanism includes an internally threaded hole formed in the outer ring such as to extend in an axial direction, a screw hole formed in the inner ring, and a screw member that passes through the screw hole and engages with the internally threaded hole.

3. The overload protection device according to claim 1, wherein the torque adjustment mechanism includes:
a restricting portion provided to one or both of the inner rotating member and the outer rotating member to restrict axial movement of one or both of the inner ring and the outer ring;
a pressing member configured to press one or both of the inner ring and the outer ring toward the restricting portion;
an internally threaded hole formed either in the inner rotating member or the outer rotating member such as to extend in an axial direction;
a screw hole formed in the pressing member; and
a screw member that passes through the screw hole and engages with the internally threaded hole.

4. The overload protection device according to claim 1, wherein a static friction between the inner transmission surface and the outer circumferential surface of the inner rotating member is smaller than a static friction between the outer transmission surface and the inner circumferential surface of the outer rotating member.

5. The overload protection device according to claim 1, wherein the inner transmission surface is a surface that has been subjected to surface treatment.

6. The overload protection device according to claim 5, wherein the surface treatment of the inner transmission surface is coating with a high hardness material.

7. The overload protection device according to claim 6, wherein the inner transmission surface has a surface with a hardness of HV1500 or more.
